(19) United States
(12) Patent Application Publication
(10) Pub. No.: US 2020/0363623 A1
(43) Pub. Date: Nov. 19, 2020

(54) DUAL FOCAL PLANE RETICLES FOR OPTICAL SIGHTING DEVICES

(71) Applicant: Sheltered Wings, Inc. d/b/a Vortex Optics, Barneveld, WI (US)

(72) Inventor: David M. Hamilton, Barneveld, WI (US)

(21) Appl. No.: 16/984,857

(22) Filed: Aug. 4, 2020

Related U.S. Application Data
(63) Continuation of application No. 14/478,697, filed on Sep. 5, 2014, now abandoned.
(60) Provisional application No. 61/874,840, filed on Sep. 6, 2013.

(51) Int. Cl. G02B 23/14; G02B 25/00

(52) U.S. Cl. CPC G02B 23/14; G02B 25/001

(57) ABSTRACT

A dual focal plane optical sighting device, such as a riflescope, having two reticles, one of which is an electronic reticle. The optical system has an objective lens system, an eyepiece lens, and an erector system, with two focal planes, a first reticle at the first focal plane, and a second reticle at the second focal plane, and at least one of the reticles is an electronic reticle.

### CROSS-REFERENCE TO RELATED APPLICATIONS

This application is a continuation patent application of U.S. patent application Ser. No. 14/478,697 filed Sep. 5, 2014, which claims the benefit of U.S. Provisional Patent Application Ser. No. 61/874,840, filed Sep. 6, 2013, which is incorporated herein by reference in its entirety for all purposes.

### FIELD OF THE INVENTION

The present invention relates generally to optical sighting devices for use with firearms. More particularly, the present invention relates to reticles for use in a dual focal plane optical sighting device.

### BACKGROUND

Reticles are used in optical sighting devices for aiming and for measuring distances or sizes of objects. Various types of reticles can be used in optical sighting devices, such as riflescopes. Wire crosshairs have been used in reticles for many years.

More recently, glass etched reticles have become popular in sighting devices used in the consumer, military, and law enforcement markets. A glass etched reticle is a piece of glass with a pattern etched into the glass then, using a vapor deposit chamber, various substances can be deposited into the etched pattern. For black features, chrome is generally used. For “illuminated” features, titanium dioxide or sodium silicate is generally used. This fine powder reflects light from a LED, which is positioned at the edge of the reticle housing and out of view of the user, towards the user's eye, and makes the reticle pattern appear to glow so it is easy to see in low light situations.

Most optical sighting devices with variable magnification have two focal planes. Generally a reticle could be placed at the first focal plane, the second focal plane or both. There are distinct advantages and disadvantages to both first and second focal plane reticles.

First focal plane reticles generally have smaller features, which usually prevents the use of wire reticles, because the wires are too big. Therefore, glass etched reticles are generally used for first focal plane reticles. Since the first focal plane is in front of the zoom magnification system (that is, the erector system), the reticle and image will change in size in proportion to one another: when the image gets bigger, the reticle gets bigger at the same rate. One advantage to this is that any measurement marks on the reticle will be accurate at any magnification setting the user chooses. As the image is magnified, the reticle appears to get larger along with the image at the same rate, so all reticle markings will be accurate to its designed scale of measurement. One disadvantage, however, is that the lines which make-up the reticle will get thicker to the user's eye, making it difficult to see small targets. If the lines are too thin, at low magnification (desirable for larger fields of view and moving targets) the lines could be too thin to be seen clearly. On the other hand, if the lines are thicker and work well at low magnification, they may appear to be too thick at higher magnifications.

In second focal plane reticles, by contrast, the advantages and disadvantages are largely the opposite of those of first focal plane reticles. Second focal plane reticles do not adjust in size or scale when the magnification is changed because they are located behind the erector system. Therefore, a second focal plane reticle is generally sized for a specific magnification setting of the riflescope. If a second focal plane reticle is not used at the precise magnification setting for which the given reticle is designed, any bullet drop marks or measurement marks will not be accurate. In that case, the user would need to mathematically calculate the difference for accurate use. An advantage of second focal plane reticles is that the lines can be optimized for the most desirable thickness, and at any magnification the lines will appear the same thickness to the user's eye.

Some trends in current sighting devices are worth noting. For example, there is a trend in sighting devices to have an increased magnification range. It is not uncommon to see 6× magnification ranges and some scopes even have magnification ranges in the 10× or more range. As magnification ranges become greater, it becomes more difficult to optimize the line thickness of reticles used in the first focal plane because there is a much larger change in reticle size over that zoom range. Another trend is to use one optical sighting device for both long range situations and close range situations. With increased zoom ranges, it is possible to have one optical sighting device that can cover both very close and very far situations. However, because of the advantages and disadvantages described above, it is difficult to find a reticle that is optimal for both long range situations and close range situations.

In the last few years certain optical sighting devices have used dual focal plane reticles. This means that the device contains two reticles; one reticle in each of the first and second focal planes. Generally, most dual purpose (close and far application) reticles will have vertical and horizontal stadia lines with hash marks or some other shape designating specific angular measurements (e.g., Minutes of Angle or Milliradians) for long range shots. For shorter range shooting, a simple dot, horseshoe shape, broken circle, or some other mark is preferred. Both reticles in all dual focal plane optical sighting devices currently known to the inventor are glass etched reticles.

The use of transparent organic light-emitting diode (OLED) screens or other electronic reticles is already known in the prior art, but improvements could be made on this technology. For example, U.S. Patent Application Publication Number 2013/0033746 discloses a transparent OLED screen reticle as well as other types of electronic reticles, and various electronic reticle shapes. One problem with electronic reticles including OLED reticles, however, is that if battery power is lost, so too is the reticle. In this situation, there are no aiming options. Another disadvantage is that it can be complicated to connect the OLED screen to the magnification. Such difficulty leads to more opportunities for failure and an increase in cost and complexity.

As such, there is a need for devices and methods that allow for having portions of a reticle change with magnification while other portions do not, and, at the same time, having the backup of a physical reticle if all battery power fails.

### BRIEF DESCRIPTION OF THE DRAWINGS

FIG. 1 is a top perspective view of a riflescope optical sighting device in accordance with the present invention.

FIG. 2 is a cross-section view of the riflescope of FIG. 1. Showing a moveable optical element inside the scope body.

FIG. 3 is a close-up cross section view of the erector system in the optical element of an optical sighting device in accordance with the present invention.

FIG. 4 is a schematic cross-section view of an optical sighting device with two focal planes and reticles at each focal plane.

FIG. 5 is a view through a dual focal plane optical sighting device with dual reticles, where the two reticles are misaligned.

FIG. 6 is a view as seen when looking through a dual focal plane optical sighting device using glass and electronic reticles.

FIG. 7 illustrates an electronic reticle with a marking pattern for use with a supersonic bullet.

FIG. 8 illustrates an observed reticle with a marking pattern for use with a subsonic bullet.

### SUMMARY

An optical sighting device includes an objective lens system, an eyepiece lens, and an erector lens system forming an optical system having a first focal plane and a second focal plane, the first focal plane proximate the objective lens system, and the second focal plane proximate the eyepiece lens. The optical system has a first reticle at the first focal plane and a second reticle at the second focal plane and at least one of those reticles is an electronic reticle. An electronic reticle may be either at the first focal plane or the second focal plane.

A dual focal plane optical sighting device adapted to be used with a supersonic and a subsonic bullet, the optical sighting device including an electronic reticle, a controller for causing at least two marking patterns to be displayed on the electronic reticle, the first pattern illustrating angular markings for use with the supersonic bullet, and the second pattern illustrating angular markings for use with the subsonic bullet.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### DETAILED DESCRIPTION

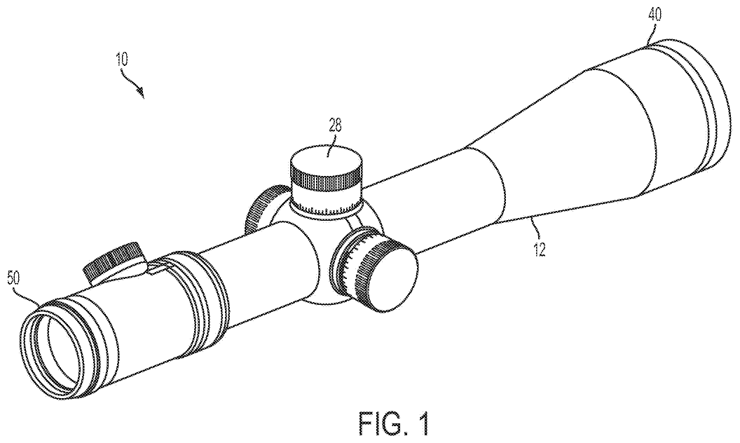

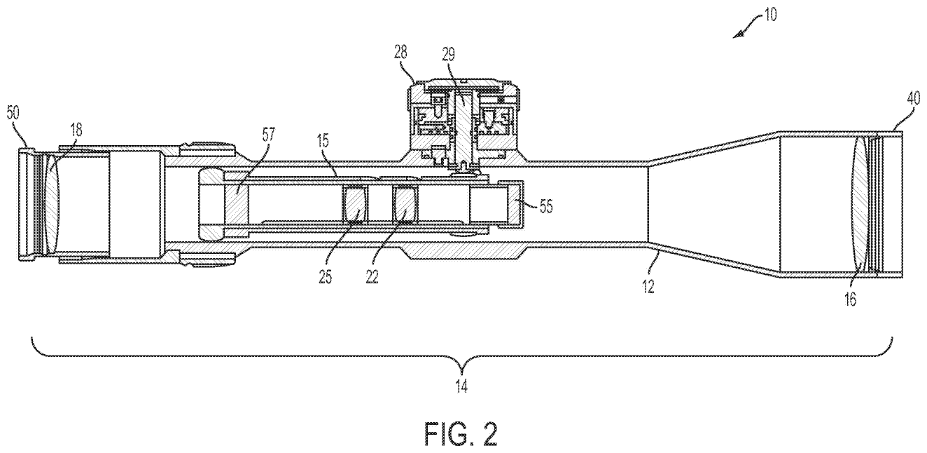

FIG. 1 shows an exemplary dual focal plane optical sighting device 10, having a scope body 12, objective lens end 40 and eyepiece end 50. FIG. 2 shows a cross-section of the sighting device from FIG. 1 showing the basic components of optical system 14 and moveable optical element 15. As shown in FIG. 2, optical system 14 includes an objective lens system 16, erector system 25, and eyepiece 18. FIG. 2 shows a riflescope embodiment of the invention having a body 12, but optical system 14 could be used in other types of sighting devices as well. Erector system 25 may be included within a moveable optic element 15. In FIG. 2, moveable optic element 15 also includes a collector 22, as well as first reticle 55 and second reticle 57. When in use, adjustment of turret assembly 28 and turret screw 29 causes adjustment of moveable optic element 15.

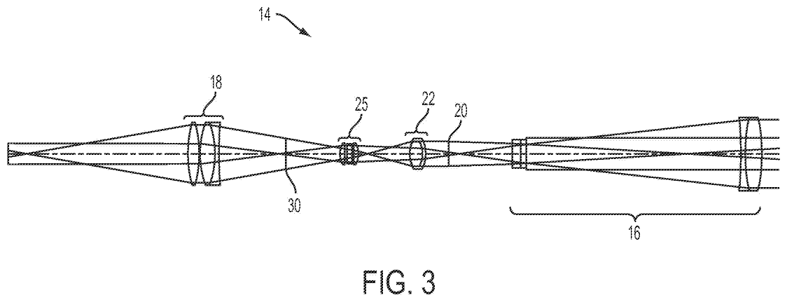

FIG. 3 shows a close-up view of an optical system 14 in cross-section, illustrating how light rays travel through the optical system 14. Optical system 14 may have additional optical components such as collector 22, and it is well known within the art that certain components, such as objective lens system 16, erector system 25, and eyepiece 18 may themselves have multiple components or lenses. Optical system 14 shown here is drawn as a basic system for illustration of one embodiment of the invention but it should be understood that variations of other optical systems with more or less structural components would be within the scope of the invention as well.

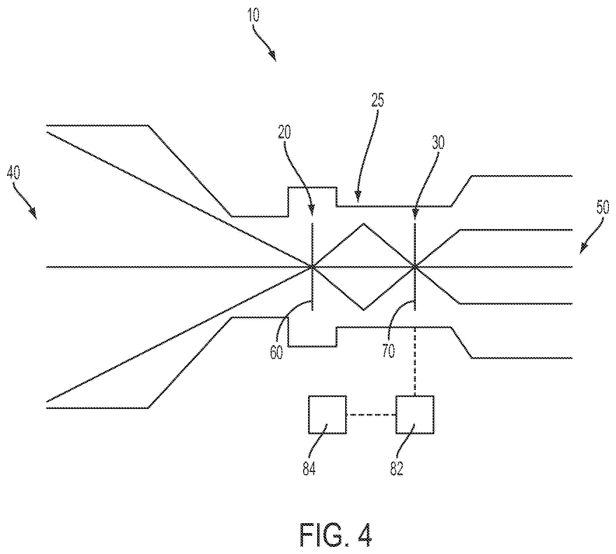

FIG. 4 is a schematic drawing of the basic components of one embodiment of a dual focal plane optical sighting device 10, having an objective lens end 40 and an eyepiece end 50. The focal plane proximal to the objective lens end 40 is a first focal plane 20 (FFP). The focal plane closer to the eyepiece end is a second focal plane 30 (SFP). Light enters the objective lens end 40 and proceeds through the dual focal plane optical sighting device 10 and through the eyepiece end 50. As light passes through the dual focal plane optical sighting device 10, light is focused to form an image that is clear to the eye of a user at the first 20 and second 30 focal planes. Magnification occurs in an erector system 25 located between the first and second focal planes. FIG. 4 also shows optional components controller 82 and switch 84. Controller 82 may contain a chip with memory for storing various reticle patterns or other information used by the device.

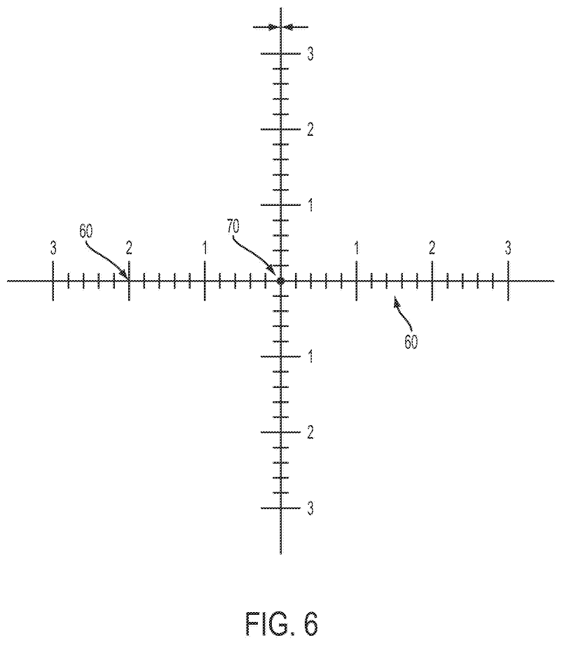

In one embodiment of a dual focal plane optical sighting device 10, a glass reticle 60 (such as a glass etched reticle) is positioned at the first focal plane 20 and an electronic reticle 70 (such as an OLED reticle) is positioned in the second focal plane 30. The pattern on the glass reticle 60 could be a cross hair with hash marks, for example, and the pattern of the electronic reticle 70 could be a dot as seen in FIG. 6. It should be understood that numerous other types and shapes of reticles and reticle patterns could be used as well.

In an alternate embodiment, the electronic reticle 70 is placed on the same focal plane as the glass reticle 60. In yet another alternate embodiment, the electronic reticle 70 could be positioned at the first focal plane 20 and the glass reticle 60 positioned at the second focal plane 30. In additional embodiments, wire reticles could be used in either focal plane position.

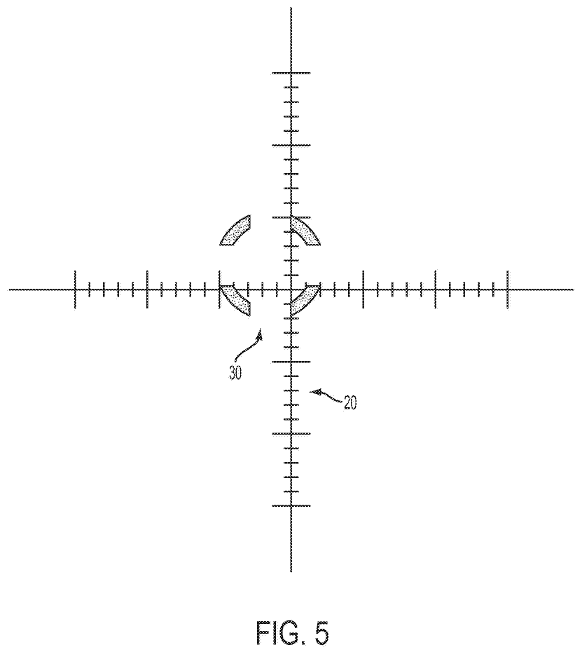

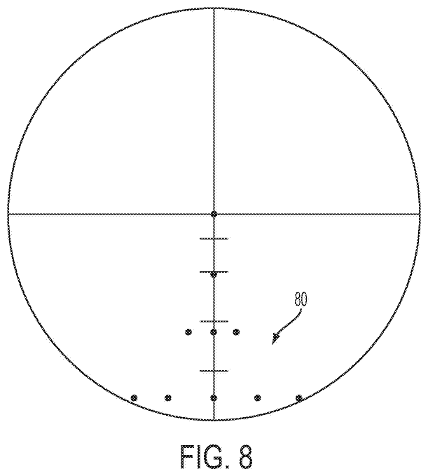

With any dual focal plane optical sighting device, the two reticles have to be properly aligned so that when they are viewed by a user from the eye piece, the reticles appear aligned as seen in FIG. 8. If not properly aligned, the reticles may appear misaligned to the user's eye as shown in FIG. 5. If the alignment between the first focal plane reticle and the second focal plane reticle is off by only a small fraction of a millimeter, it will be very noticeable to the user. When the two reticles are properly aligned, it is called the “true position.”

In a dual focal plane optical sighting device 10 the first focal plane 20 and second focal plane 30 may be rather far apart and the reticles themselves are physically rather small (although through the eyepiece they may appear large). For example, glass etched reticles are generally about 10 microns, and some reticles have lines that are 0.005 mm thick. As another example, the first focal plane and second focal plane could be separated by a distance of 50-100 mm within the body of a sighting device. As such, it is difficult to get a precise alignment over that distance. Alignment of such small reticles requires very small movements. If the dual focal plane optical sighting device features two glass etched reticles, alignment must be done mechanically to a high degree of precision, which is difficult and costly to accomplish. Alternatively, if the dual focal plane optical sighting device features two electronic reticles, a power failure results in having no reticle at all. Thus, one advantage of having one glass reticle 60 and one electronic reticle 70 in a dual focal plane optical sighting device 10 is to simplify the complexity and cost of mechanically aligning the two reticles. Dual reticle alignment can be simplified by requiring less or even no mechanical alignment, depending on the manufacturing process used. For example, electronic reticle 70 could be digitally aligned with glass etched reticle 60 using computerized or automated processes. Some OLED screen reticles have pixels that are under 5 microns. Since this is about half the line width of the glass reticle, it easier to align the digital reticle. Further, should a power failure occur with the optical sighting device, the glass reticle will remain visible and operative as a backup aiming solution.

The dual focal plane optical sighting device 10 could also have a memory chip or internal processor, for example within controller 82, which contains various electronic reticle options, such as the dot from FIG. 6, the broken circle from FIG. 5 or a horseshoe. Additionally, a user interface such as a screen or dial could be used to toggle between the various reticle choices. Once two reticles within the dual focal plane optical sighting device 10 are digitally aligned, the electronic reticle options can be optimized to work with the glass reticle 60 and provide the user many reticle options to choose from.

In some embodiments, the optical sighting device 10 can also be particularly useful with firearms that can accommodate both a supersonic bullet and a subsonic bullet. For example, the 300 blackout bullet is a bullet that can be used either way, although in other rifles, different bullets can be used for each function. Supersonic is faster and carries more energy. Subsonic is much quieter, especially when used with a sound suppressor or silencer on a rifle. Certain shooters, such as special operations shooters, like to have both options, and like to interchange which bullet type they use based on the mission.

The optical sighting device 10 of this disclosure can accommodate this interchangeability. In one embodiment, the optical sighting device 10 is adapted to be used with a supersonic bullet and a subsonic bullet. The optical sighting device 10 can include a controller 82 including a memory chip or internal processor for causing at least two marking patterns to be displayed on the electronic reticle, the first pattern 75 illustrating hold over or angular markings for use with the supersonic bullet, and the second pattern 80 illustrating hold over or angular markings for use with the subsonic bullet, the second pattern having greater spacing between the markings than in the first pattern.

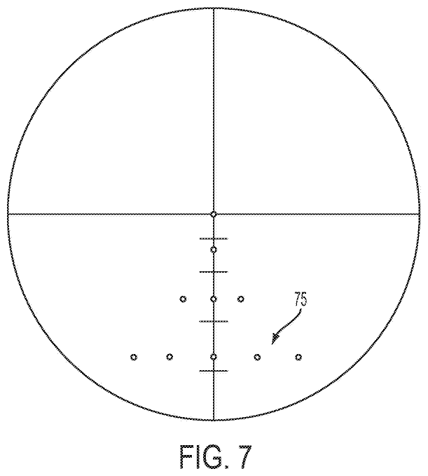

Further, when the glass reticle 60 is in the second focal plane with a few hash marks, and the electronic reticle 70 is in the first focal plane, a switch 84 on the riflescope changes a series of drop dots or other “hold over” aiming points or angular markings based on the bullet used (subsonic vs. supersonic). Different colors, shapes, or any combination thereof can be used to differentiate between the hold-over features, depending on whether supersonic or subsonic was selected. In the embodiment illustrated in FIGS. 7 and 8, pressing the switch 84 on the side of the device 10 changes the dots between a supersonic pattern (FIG. 7) and subsonic pattern (FIG. 8). Supersonic patterns and subsonic patterns may also be illuminated in different colors to further differentiate them. Any combination of colors and/or shapes could be used to denote between supersonic and subsonic. Since the subsonic is a slower bullet, it will see more bullet drop over a given distance than a supersonic bullet. As a result, the hold-over dots need to be spaced out more, as illustrated in comparing FIG. 7 and FIG. 8, in order to accommodate this greater amount of bullet drop. Again, one benefit of the second focal plane reticle illustrated in FIGS. 7 and 8 having glass etched markings, is that in the event that battery power fails (and thus the illuminated dots from the first focal plane reticle are unavailable), the shooter still has the benefit of the second focal plane reticle for reference.

In any of the embodiments disclosed herein, a glass etched or non-electronic reticle can also have basic angular markings (MOA or MRAD) hashed to be used if battery power fails, with the dots corresponding to a crosswind speed.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An optical sighting device comprising:
a body with a first end and a second end;
an objective lens system disposed within the body;
an eyepiece lens disposed within the body;
an erector lens system disposed within the body; the objective lens system, eyepiece lens, and erector lens system forming an optical system having a first focal plane
a first reticle at the first focal plane, wherein the first reticle is a glass reticle;
an electronic reticle placed on the same focal plane as the first reticle, and wherein the electronic reticle is configured to selectively display one of at least two marking patterns, wherein the at least two marking patterns are (a) a series of drop dots or other hold over aiming points or angular markings corresponding to a supersonic pattern and (b) a series of drop dots or other hold over aiming points or angular markings corresponding to a subsonic pattern, and the first reticle comprises at least one display pattern selected from a cross hair, a series of hash marks and combinations thereof.

2. The optical sighting device of claim 1, further comprising memory for storing multiple reticle patterns for display on the electronic reticle.

3. The optical sighting device of claim 1, wherein the electronic reticle includes an OLED.

4. An optical system for a sighting device, the system comprising:
an objective lens system;
an eyepiece lens;
an erector lens system, the objective lens system, eyepiece lens, and erector lens system forming an optical system having a first focal plane;
a first reticle at the first focal plane;
an electronic reticle placed on the same focal plane as the first reticle, and wherein the electronic reticle is configured to selectively display one of a variety of reticle pattern options.

5. The optical sighting device of claim 4, wherein the first reticle is a glass reticle.

6. The optical sighting device of claim 4, further comprising memory for storing the at least two reticle patterns for display on the electronic reticle.

7. The optical sighting device of claim 4, wherein the electronic reticle includes an OLED.

8. An optical sighting device adapted to be used with a supersonic bullet and a subsonic bullet, the optical sighting device including a first reticle at a first focal plane and an electronic reticle placed on the same focal plane as the first reticle, a controller for causing at least two marking patterns to be displayed on the electronic reticle, the first pattern illustrating angular markings for use with the subsonic bullet, the second pattern having greater spacing between the markings than in the first pattern.

9. The optical sighting device according to claim 8 wherein the optical sighting device further includes a switch connected to the controller for switching between the first and second patterns.

10. The optical sighting device of claim 8 further comprising an additional reticle that is a glass reticle or a wire reticle.

11. The optical sighting device of claim 10, wherein the additional reticle comprises at least one display pattern selected from a cross hair, a series of hash marks and combinations thereof.

12. The optical sighting device of claim 1, wherein the glass reticle displays a series of hashmarks.

13. The optical sighting device of claim 1, further comprising memory for storing the at least two reticle patterns for display on the electronic reticle.

14. The optical sighting device of claim 13, further comprising a controller for causing the at least two reticle patterns to be selectively displayed on the electronic reticle.

15. The optical sighting device of claim 14, further comprising a switch connected to the controller for switching between the at least two patterns.
